(19) United States
(12) Patent Application Publication
(10) Pub. No.: US 2026/0147455 A1
(43) Pub. Date: May 28, 2026

(54) NON-TRANSITORY COMPUTER-READABLE STORAGE MEDIUM STORING APPLICATION PROGRAM, ELECTRONIC DEVICE, AND CONTROL METHOD FOR CONTROLLING ELECTRONIC DEVICE

(71) Applicant: CANON KABUSHIKI KAISHA, Tokyo (JP)

(72) Inventor: Keisuke MIZUTANI, Kanagawa (JP)

(21) Appl. No.: 19/390,349

(22) Filed: Nov. 14, 2025

(30) Foreign Application Priority Data
Nov. 26, 2024 (JP) 2024-205842

(51) Int. Cl. G06F 3/0484; G06F 3/0482

(52) U.S. Cl. CPC G06F 3/0484; G06F 3/0482

(57) ABSTRACT

An electronic device manages each of multiple apps in association with any of multiple spaces including first and second spaces, in which a lock must be unlocked to access the second space. The electronic device performs control in response to an operation such that, in a case where a running app is associated with the first space, a first screen that is used for selecting content saved in association with the first space is displayed, and on the first screen, a first display item enabling selection of content saved in association with a space other than the space with which the running app is associated is not displayed, and, in a case where the app is associated with the second space, a second screen that is used for selecting content saved in association with the second space is displayed, and on the second screen, the first display item is displayed.

### BACKGROUND

### Field of the Technology

The present disclosure relates to an electronic device that manages content, application software, or both in association with any one of multiple spaces, a control method for controlling the electronic device, and a non-transitory computer-readable storage medium storing an application program.

### Description of the Related Art

A technique for concealing electronic content is known. Japanese Patent Application Laid-Open No. 2009-201163 discusses a method for generating secure polarized electronic content from electronic content. Electronic content includes a data portion and a format portion. In this method, a secured polarization engine selects a polarization scheme, and the secured polarization engine identifies a system resource. The system resource can be used by an interpretation application to interpret the electronic content as presentation data that can be processed by an output apparatus. The secured polarization engine determines a parameter of the system resource to be converted by the polarization scheme. The secured polarization engine polarizes a digital work according to the polarization scheme for converting the data portion of the electronic content into a polarized data portion, thereby generating secure polarized electronic content. The secure polarized electronic content includes the polarized data portion and the format portion and also maintains the structure of the digital work, whereby the polarized digital work can be interpreted by the interpretation application.

“Function of Android 15 and Overview of API,” [searched on Jul. 30, 2024], the Internet <URL:https://developer.android.com/about/versions/15/features#private-space>, discusses a private space where a user can create another space on a device and save a highly confidential app using an additional authentication layer, regarding Android 15, which is an operating system (OS) of a smartphone.

In Android 15, a private space can be created in addition to a personal space. However, between the personal space and the private space, content and an app cannot be confirmed across the spaces, except for some apps and functions. Thus, it is difficult for a user to find a desired content or app. A similar issue arises not only in the personal space and the private space in Android 15, but also in a mechanism for managing an app and content in association with separated areas (spaces) in which confirmation is not allowed from at least one area to another area without authentication.

### SUMMARY

The present disclosure is directed to enable a user to suitably operate a mechanism that manages an app and content in association with any one of multiple spaces.

A non-transitory computer-readable storage medium storing an application program including instructions, which when executed by one or more processors of an electronic device, in which each of a plurality of applications is managed in association with any of a plurality of spaces including a first space in which a lock does not need to be unlocked to access the first space and a second space in which the lock needs to be unlocked to access the second space, cause the electronic device to: perform control in response to an operation for selecting content to be processed such that, in a case where the application program is associated with the first space, a first screen that is used for selecting content saved in association with the first space is displayed, and on the first screen, a first display item enabling selection of content saved in association with the first space or the second space other than a space with which the application program is associated is not displayed, and, in a case where the application program is associated with the second space, a second screen that is used for selecting content saved in association with the second space is displayed, and on the second screen, the first display item is displayed.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of the structure of an information processing system.

FIG. 2 illustrates an example of the structure of an electronic device.

FIG. 3 is a diagram illustrating application programs and content that are saved in the electronic device.

FIG. 4 illustrates an example of a screen that is displayed on a display section of the electronic device.

FIGS. 5A and 5B illustrate a flowchart describing the processing of a print app.

FIG. 6 illustrates an example of a home screen of the print app that is displayed.

FIG. 7 illustrates an example of a file selection screen that is displayed by the Storage Access Framework (SAF).

FIG. 8 illustrates an example of a document data source selection screen that is displayed by the print app.

FIG. 9 illustrates an example of a save destination selection screen that is displayed by the SAF.

FIGS. 10A and 10B illustrate examples of a folder selection screen that is displayed by the SAF.

FIG. 11 illustrates a flowchart of a file selection process performed by the SAF.

FIG. 12 illustrates an example of a scan process result screen that is displayed.

FIG. 13 illustrates a flowchart of a photograph selection process performed by a photo picker.

FIG. 14 illustrates an example of an image list screen that is displayed by the photo picker.

FIG. 15 illustrates an example of an album selection screen that is displayed by the photo picker.

FIG. 16 illustrates an example of an image list screen that is displayed by the photo picker.

FIG. 17 illustrates a flowchart of a file sharing process performed by the print app.

FIG. 18 illustrates an example of an app selection screen that is displayed by the print app.

FIG. 19 illustrates an example of an app selection screen that is displayed by a standard sharing function of an OS.

### DESCRIPTION OF THE EMBODIMENTS

Embodiments of the present disclosure will be described below with reference to the drawings. The following exemplary embodiments do not limit the appended claims, and not all the combinations of the features described in the exemplary embodiments are essential for a method for solving the issues in the present disclosure. In the present exemplary embodiment, if an application program is started in a private space or a personal space, even if desired content or a desired app is present in a space different from the space where the application program is started, a user is assisted in selecting the desired content or app. Hereinafter, application software or an application program is abbreviated as an “application” or an “app.”

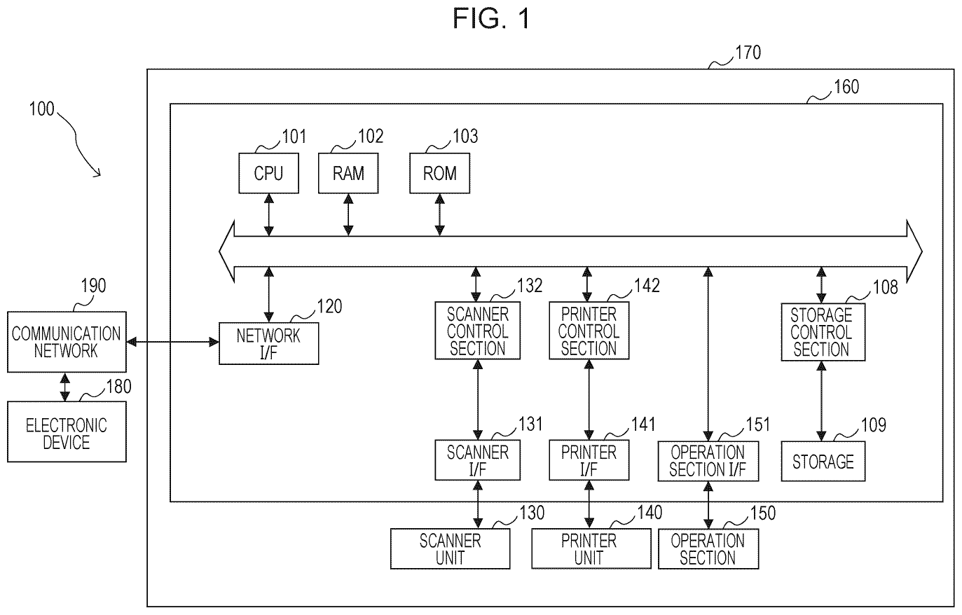

FIG. 1 is a diagram illustrating an example of the configuration of an information processing system 100 according to an exemplary embodiment of the present disclosure. The information processing system 100 includes an image forming apparatus 170, an electronic device 180, and a communication network 190.

For example, the image forming apparatus 170 is a multifunction peripheral (MFP) having a plurality of functions such as a scanner function, a print function, a copy function, and a communication function with an external apparatus. The image forming apparatus 170 may be a printer instead of an MFP.

The electronic device 180 is, for example, a smartphone. The electronic device 180 is not limited to a smartphone and may be a tablet or a personal computer. The electronic device 180 only needs to be a device that can be caused to operate by installing an application program.

The electronic device 180 and the image forming apparatus 170 can communicate with each other via the communication network 190. The electronic device 180 can transmit a print job or a scan job to the image forming apparatus 170 via the communication network 190. The image forming apparatus 170 can receive a print job or a scan job and execute printing or scanning.

The image forming apparatus 170 includes a scanner unit 130, a printer unit 140, an operation section 150, and a controller section 160. The controller section 160 includes a central processing unit (CPU) 101, a random-access memory (RAM) 102, a read-only memory (ROM) 103, a storage control section 108, storage 109, and a network interface (I/F) 120. Further, the controller section 160 includes a scanner I/F 131, a scanner control section 132, a printer I/F 141, a printer control section 142, and an operation section I/F 151.

The CPU 101 executes a software program stored in the RAM 102 and controls the entirety of the image forming apparatus 170.

For example, the ROM 103 stores a program and a fixed parameter regarding the start of the controller section 160.

The RAM 102 is used to store a program and temporary data when the CPU 101 controls the image forming apparatus 170. The program and the temporary data stored in the RAM 102 are read from the ROM 103 or the storage 109.

When a scan process is performed via the scanner I/F 131, the scanner control section 132 receives setting information set by a user through communication with the CPU 101 and controls the operation of the scanner unit 130 based on the setting information.

When a print process is performed via the printer I/F 141, the printer control section 142 receives setting information set by the user through communication with the CPU 101 and controls the operation of the printer unit 140 based on the setting information.

The operation section I/F 151 is an interface with the operation section 150 that includes a liquid crystal display device unit on which a touch panel operation can be performed. The CPU 101 executes an operating system (OS) and an application program, thereby generating screen display image data that is to be displayed on the operation section 150, and outputting the screen display image data from the operation section I/F 151 to the operation section 150. The CPU 101 also executes the OS and the application program, thereby acquiring information input as a user operation from the operation section 150 via the operation section I/F 151.

The storage 109, as main storage, stores a program executed by the CPU 101, a program management table, and various pieces of data, and is controlled to transmit and receive data by the storage control section 108. The storage 109 can also reserve a print job. The program executed by the CPU 101 is a boot program executed by the CPU 101 to start the OS when the image forming apparatus 170 starts. In a case where a print job is reserved, print information such as the number of images, a color/monochrome type, one-sided/two-sided, and enlargement/reduction is stored. If the user reserves a print job and then gives an instruction to perform printing, printing is executed. Examples of the storage 109 include a hard disk drive (HDD), a solid-state drive (SSD), an embedded MultiMediaCard (eMMC), a NOT AND (NAND) Flash Memory, and a NOT OR (NOR) flash memory.

The network I/F 120 transmits and receives data to and from the communication network 190. The network I/F 120 receives data sent from the communication network 190 and transmits image data read by the scanner unit 130 or image data saved in the storage 109 to the electronic device 180 via the communication network 190.

According to a scan instruction based on an operation on the operation section 150 or a scan job received from the electronic device 180, the CPU 101 controls the scanner unit 130. The scanner unit 130 reads an original document and generates binary monochrome or multivalued color image data.

According to a print instruction based on an operation on the operation section 150 or a print job received from the electronic device 180, the CPU 101 controls the printer unit 140. The printer unit 140 prints image data generated by the scanner unit 130 or print data received from the electronic device 180 on a print sheet.

The operation section 150 includes a display section (a liquid crystal display) that displays the state of the image forming apparatus 170 to the user, and an input mechanism such as a button and/or a touch panel that receives an input to the image forming apparatus 170 provided by the user.

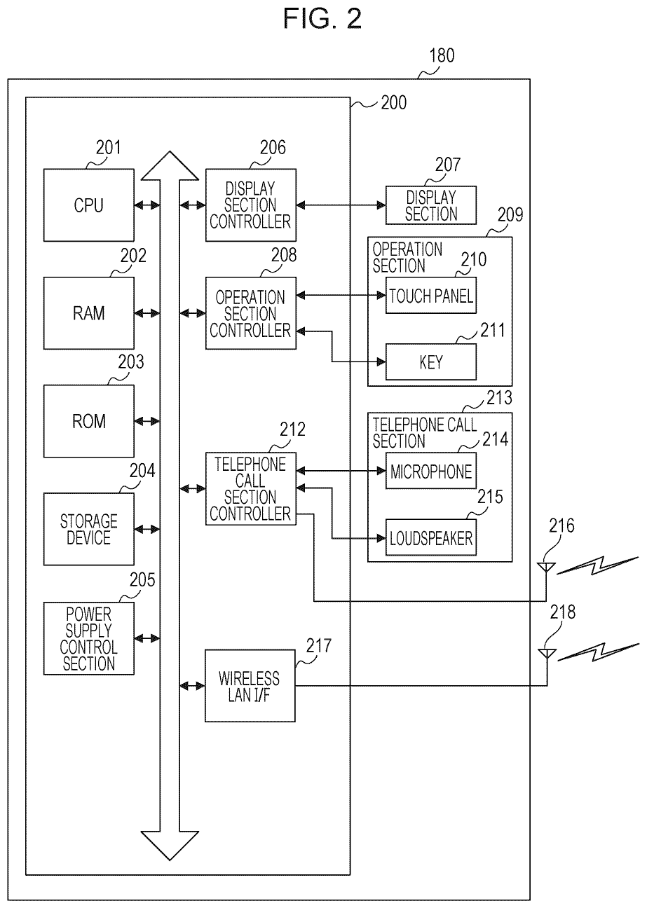

FIG. 2 is a diagram illustrating an example of the configuration of the electronic device 180 in FIG. 1. The electronic device 180 is, for example, a smartphone. The electronic device 180 includes a controller section 200, a display section 207, an operation section 209, a telephone call section 213, a sound antenna 216, and a wireless local area network (LAN) antenna 218.

The controller section 200 includes a CPU 201, a RAM 202, a ROM 203, a storage device 204, a power supply control section 205, a display section controller 206, an operation section controller 208, a telephone call section controller 212, and a wireless LAN I/F 217. The operation section 209 includes a touch panel 210 and a key 211. The telephone call section 213 includes a microphone 214 and a loudspeaker 215.

The CPU 201 is a central processing unit that controls the entirety of the electronic device 180.

The RAM 202 is a work memory for the CPU 201 to operate and is used to load various programs and save the result of a calculation process. The ROM 203 is a memory in which a startup program for the CPU 201 and various pieces of setting information are saved. The storage device 204 is a non-volatile memory in which a large-sized program and data are saved and is a flash memory or an HDD inside the controller section 200.

The power supply control section 205 includes a battery and a charging module for the battery in order to control power required for the electronic device 180 to operate. The display section controller 206 transmits image data to the display section 207 in accordance with a communication protocol for the display section 207.

The operation section controller 208 receives an input from the touch panel 210 or the key 211 and converts the input into data that can be interpreted by the CPU 201. The touch panel 210 and the display section 207 are integrally formed, and the touch panel 210 can detect a touch operation performed on a display surface of the display section 207.

The telephone call section controller 212 performs a process for converting a sound signal received from the microphone 214 into a radio wave to be transmitted to an opposing device and outputting the radio wave to the sound antenna 216, or converting a radio wave received from the opposing device by the sound antenna 216 into a sound signal and outputting the sound signal to the loudspeaker 215.

The wireless LAN I/F 217 transmits and receives data to and from the communication network 190 via the wireless LAN antenna 218.

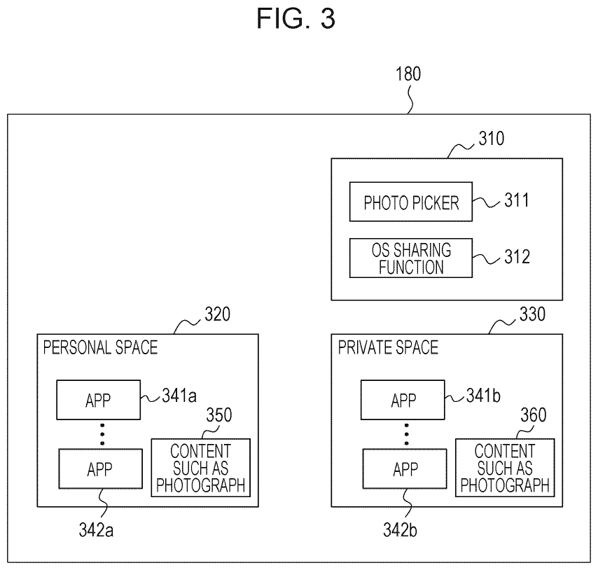

FIG. 3 is a diagram illustrating application programs and content saved in the electronic device 180. The electronic device 180 includes an OS standard function (an operating system standard function) 310, a personal space 320, and a private space 330.

For example, an OS of the electronic device 180 is Android 15. In Android 15, the user can create the private space 330 in addition to the personal space 320 on the electronic device 180. The private space 330 can save highly confidential apps 341b and 342b using a lock function.

The personal space 320 saves an app 341a, an app 342a, and content 350. In other words, the app 341a, the app 342a, and the content 350 are recorded in association with the personal space 320, which is a virtual space. More specifically, data of the app 341a, the app 342a, and the content 350 is recorded in the hierarchy of a first directory corresponding to the personal space 320. For example, the content 350 is a photograph file (an image file) or a document file and is content that can be used by the app 341a or 342a.

The private space 330 saves the app 341b, the app 342b, and content 360 such as a photograph. In other words, the app 341b, the app 342b, and the content 360, such as a photograph, are recorded in association with the private space 330, which is a virtual space. More specifically, data of the app 341b, the app 342b, and the content 360 is recorded in the hierarchy of a second directory corresponding to the private space 330. For example, the content 360 is a photograph file or a document file and is content that can be used by the app 341b or 342b. The personal space 320 and the private space 330 are spaces virtually separated from each other. The first and second directories are different directories and do not have a hierarchical relationship with each other.

The apps 341a and 341b are the same apps as each other. The apps 342a and 342b are the same apps as each other. If there is an app that the user wishes to use in both the personal space 320 and the private space 330, it is necessary to install the app in both the personal space 320 and the private space 330 (record the app in association with both the personal space 320 and the private space 330).

If the app 341a or 342a is started in the personal space 320, the app 341a or 342a can refer to the content 350 but cannot refer to the content 360 in the private space 330 unless the OS standard function 310 is used. Even if the OS standard function 310 is used, the app 341a or 342a cannot refer to the content 360 in the private space 330 unless the lock of the private space 330 is unlocked.

Similarly, if the app 341b or 342b is started in the private space 330, the app 341b or 342b can refer to the content 360 but cannot refer to the content 350 in the personal space 320 unless the OS standard function 310 is used.

The apps 341b and 342b and the content 360 in the private space 330 can be locked, and cannot be used without unlocking the lock by authentication.

For example, the OS standard function 310 includes a photo picker 311 and an OS sharing function 312. The OS sharing function 312 is a sharing function provided by the OS. If the lock of the private space 330 is unlocked, the photo picker 311 can refer to the content 350 in the personal space 320 and the content 360 in the private space 330. If the lock of the private space 330 is unlocked, the OS sharing function 312 can refer to the apps 341a and 342a in the personal space 320 and the apps 341b and 342b in the private space 330.

The photo picker 311 is a photograph selection tool for selecting a photograph as the content 350 or 360. The OS sharing function 312 is the function of selecting an app as a sharer that shares content such as an image.

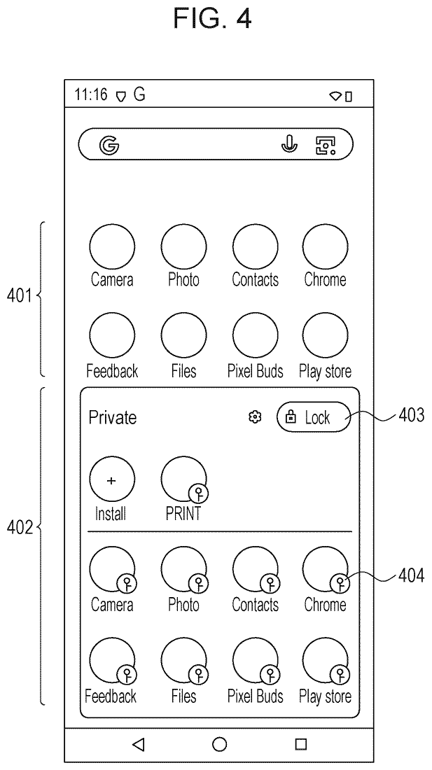

FIG. 4 is a diagram illustrating an example of an app list screen that is displayed on the display section 207 of the electronic device 180. In a display area 401, a list of apps that are installed in the personal space 320 is displayed, and startup icons (launchers) for multiple apps including the apps 341a and 342a are displayed. In a display area 402, a list of apps that are installed in the private space 330 is displayed, and startup icons for multiple apps including the apps 341b and 342b are displayed. The startup icons for the apps 341b and 342b in the private space 330 and the startup icons for the apps 341a and 342a in the personal space 320 are displayed in the display areas 401 and 402 different from each other even if the apps 341b and 342b and the apps 341a and 342a are the same apps. The display area 402 is in a display form in which the display area 402 is separated such that the outer frame of the display area 402 is surrounded by a line, and is in a display form in which the user can recognize that the display area 402 is an area visually different (a zone divided) from the display area 401. The display area 402 only needs to be in a display form in which it can be identified that the display area 402 is an area separated from the display area 401. The separation of the display area 402 may be indicated in another display form, for example, by differentiating the color or the design of the background of the display area 402 from the background of the display area 401, or separating the display area 402 by a dotted line.

The electronic device 180 can be used by unlocking a first lock. For example, the first lock is a lock on a lock screen displayed when the electronic device 180 is returned from a power-off or sleep state, or when the display section 207 is returned from a display-off state. A home screen is displayed by unlocking the first lock. A method for authenticating the unlocking of the first lock includes one or more methods from among multiple authenticating methods including passcode authentication, touch trajectory pattern authentication, fingerprint authentication, and face authentication. The private space 330 requires the unlocking of a second lock different from the unlocking of the first lock in at least one of a timing or a lock unlocking key. To use the private space 330, it is necessary to display the home screen by unlocking the first lock and then further unlock the second lock. The personal space 320 does not have a lock different from the first lock, and is basically a space that can be used so long as the home screen is displayed. An app can also be individually locked (a third lock). To use an individually locked app, it is necessary to unlock the app (unlock the third lock) even if the app is installed in the personal space 320.

In the private space 330, if the second lock is locked, the display area 402 is minimized. In the display area 402, none of app icons (startup icons) corresponding to apps present in the private space 330 is displayed, thereby preventing the apps present in the private space 330 from being started. In this state, the user cannot view what apps are present in the private space 330. If the user touches a lock icon 403 that represents a lock state of the second lock displayed in the minimized display area 402, an authentication screen is displayed. The user inputs authentication information for unlocking the second lock, whereby the second lock is unlocked. As a method for authenticating the second lock, passcode authentication, pattern authentication, fingerprint authentication, or face authentication can be used. The authentication information is a passcode, the trajectory pattern of a touch input, a fingerprint, or a captured face image. If the authentication is successful and the second lock is unlocked, the display range of the display area 402 is expanded, and the app icons (the startup icons) corresponding to the apps present in the private space 330 are displayed. In each startup icon displayed in the display area 402, a key mark 404, which is a mark indicating that an app is present in the private space 330, is displayed so that it can be identified that the app is managed differently from an app present in the personal space 320.

The private space 330 and the personal space 320 are different from each other in the root directory of the save destination of content and an app. The root directory of the save destination of content and an app in the personal space 320 is “storage/emulated/0.” The root directory of the save destination of content and an app in the private space 330 is a directory other than “storage/emulated/0” and is a directory having a number at or after “storage/emulated/10.”

If the user performs an operation for creating the private space 330 in the state where a single personal space 320 is present, the private space 330 is created. The root directory of the created private space 330 is “storage/emulated/10.”

In a case where an app is to be used in each of the private space 330 and the personal space 320, the app needs to be installed in each of the private space 330 and the personal space 320 even if the app is the same app, except for the OS standard function 310.

In a case where the second lock is not unlocked, an app installed in the private space 330 is hidden in the most recent view, a notification, a setting, and another app.

The content 350 and the apps 341a and 342a in the personal space 320 cannot be moved to the private space 330 by a user operation.

However, between the personal space 320 and the private space 330, content and an app cannot be referred across the spaces, except for the OS standard function 310. However, in some cases where an app is started in the private space 330 or the personal space 320, desired content or a desired app is present in a space that differs from the space in which the app is started. In these cases, it is difficult for the user to find the desired content or app.

In a case where an app is started in the private space 330 or the personal space 320, the present disclosure is directed to provide a method for displaying content or an app in a space that differs from the space in which the app is started.

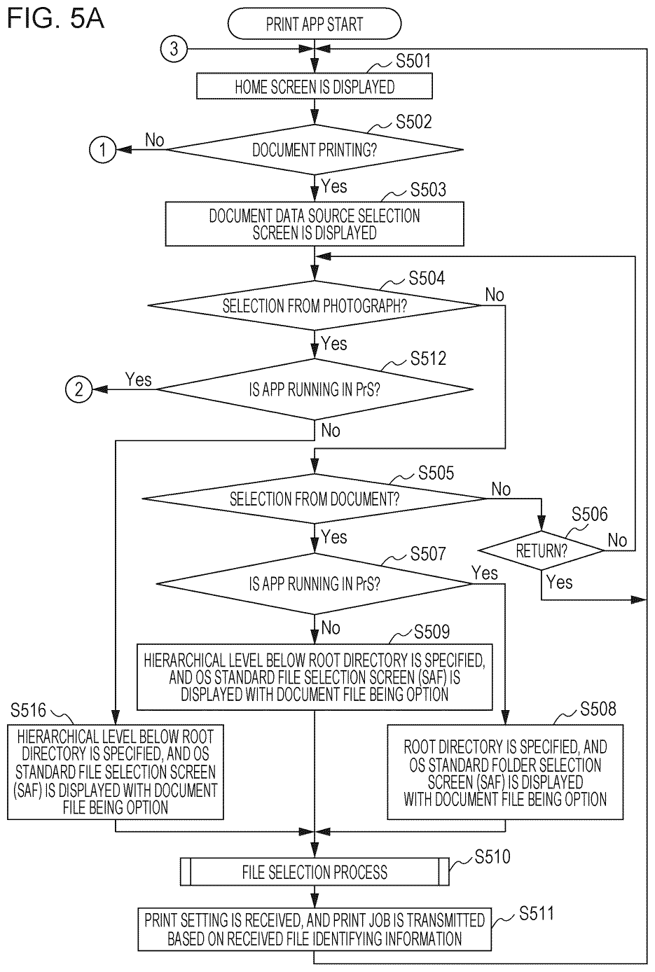

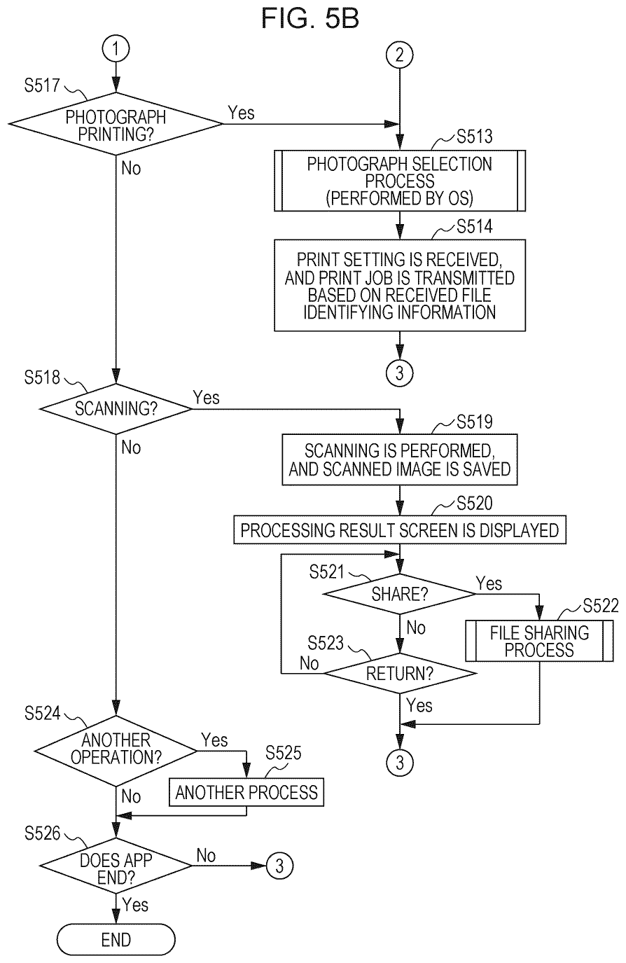

FIG. 5A and FIG. 5B illustrate a flowchart describing a control method for controlling the electronic device 180. The processing of the flowchart in FIG. 5A and FIG. 5B is achieved by the CPU 201 loading a print app recorded in the storage device 204 into the RAM 202 and executing the print app. FIG. 5A and FIG. 5B illustrate processing by the execution of the print app installed in the personal space 320 or the private space 330. The print app is an app for communicating with the image forming apparatus 170 and is an app that operates on the electronic device 180. As for each step number below, “S” will be included in front of the number.

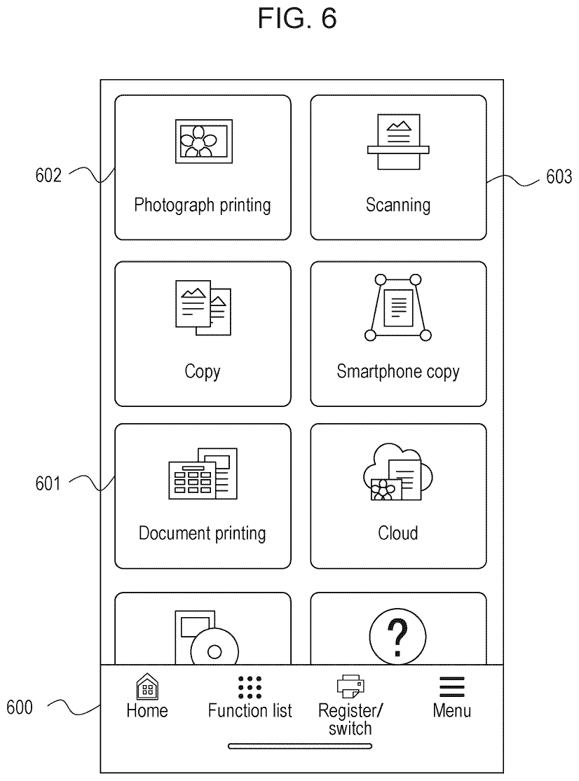

In S501, the CPU 201 performs control such that a home screen 600 of the print app, as illustrated in FIG. 6, is displayed on the display section 207 (display control). The home screen 600 enables a user operation on the touch panel 210 to select, for example, document printing 601, photograph printing 602, or scanning 603.

In S502, the CPU 201 determines whether the document printing 601 on the home screen 600 is subjected to a touch operation and thereby selected by a user operation on the touch panel 210. If the document printing 601 is subjected to a touch operation, the processing proceeds to S503. If the document printing 601 is not subjected to a touch operation, the processing proceeds to the S517. If the document printing 601 is subjected to a touch operation, content to be processed by the document printing is selected and printed. That is, a touch to the document printing 601 is an operation for selecting the content to be processed (an operation that needs to select the content to be processed).

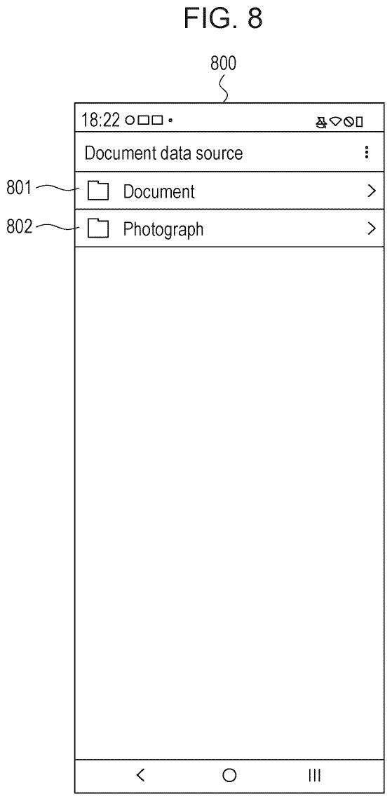

In S503, control is performed such that a document data source selection screen 800 in FIG. 8 is displayed on the display section 207. The document data source selection screen 800 enables a user operation on the touch panel 210 to select a document 801 or a photograph 802. The document 801 corresponds to a button (an operation item) for displaying a screen for selecting a document file such as a PDF file or a Word file to be printed. The photograph 802 corresponds to a button (an operation item) for displaying a screen for selecting an image file.

In S504, the CPU 201 determines whether the photograph 802 on the document data source selection screen 800 is subjected to a touch operation (selected) by a user operation on the touch panel 210. If the photograph 802 is subjected to a touch operation (selected), the processing proceeds to S512. If not, the processing proceeds to S505. If the photograph 802 is subjected to a touch operation, an image file is selected as the content to be processed by the document printing and printed. That is, a touch to the photograph 802 is an operation for selecting the content to be processed and printed (an operation that needs to select the content to be processed).

In S505, the CPU 201 determines whether the document 801 on the document data source selection screen 800 is subjected to a touch operation (selected) by a user operation on the touch panel 210. If the document 801 is subjected to a touch operation (selected), the processing proceeds to S507. If not, the processing proceeds to S506. If the document 801 is subjected to a touch operation, a document file is selected as the content to be processed by the document printing and printed. That is, a touch to the document 801 is an operation for selecting the content to be processed and printed (an operation that needs to select the content to be processed).

In S506, the CPU 201 determines whether a “return button” is subjected to a touch operation on the document data source selection screen 800. If the “return button” is not subjected to a touch operation, the processing returns to S504. If the “return button” is subjected to a touch operation, the processing returns to S501.

If the print app in the personal space 320 is started, the root directory of the personal space 320 is “storage/emulated/0.” If the print app in the private space 330 is started, the root directory of the private space 330 is “storage/emulated/10,” for example.

In S507, the CPU 201 determines whether the running print app is started in the private space (PrS) 330. If the print app is started in the private space 330, the processing proceeds to S508. If the print app is started in the personal space 320, the processing proceeds to S509.

Two determination methods in S507 will now be described. A first determination method will be first described. The CPU 201 determines that the print app is started in the private space 330 in a case where a location at which a document file (content) that is referred is stored satisfies a predetermined condition.

Specifically, the CPU 201 determines that the print app is started in the personal space 320 in a case where the location at which the document file that is referred when a file selection screen 700 is to be displayed in S508 or S509 is stored is “storage/emulated/0.”

The CPU 201 determines that the print app is started in the private space 330 in a case where the location at which the document file that is referred when the file selection screen 700 is to be displayed is stored is a directory other than “storage/emulated/0.”

In Android 15, the root directory of the personal space 320 is “storage/emulated/0.” If the user performs an operation for creating the private space 330, the private space 330 is created. The root directory of the created private space 330 is “storage/emulated/10.”

Next, a second determination method is described. The second determination method is a method for acquiring information regarding a user type from the OS and making a determination based on the acquired user type. For example, there is a case where information such as USER_TYPE_PROFILE_PRIVATE is acquired as information regarding the current user type from the OS using an application programming interface (API). If this information is acquired, it can be determined that the current user is a user of the private space 330 (the currently started app is an app in the private space 330).

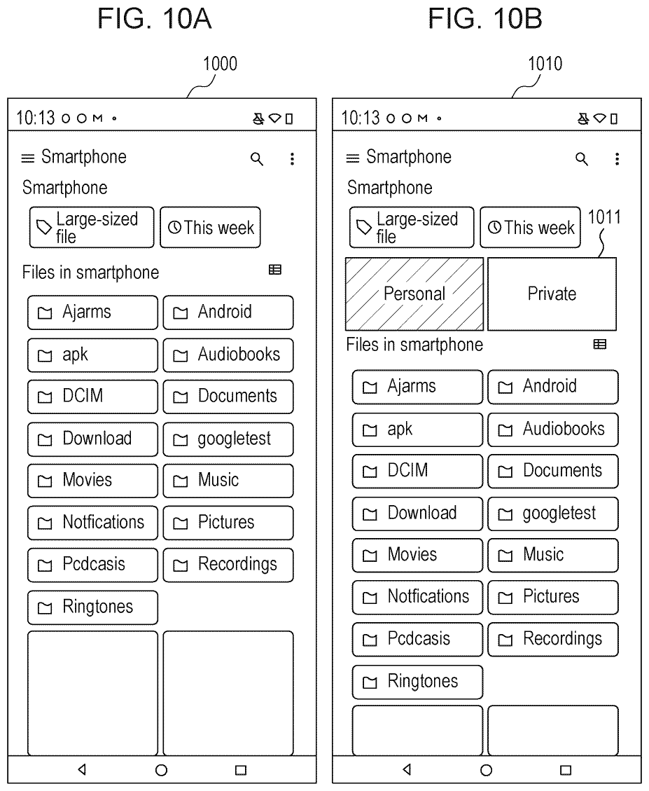

In S508, the CPU 201 displays a folder selection screen (a folder list screen) by using an OS standard file selection function that is included in the OS standard function 310. According to the present exemplary embodiment, the OS standard file selection function (tool) is Storage Access Framework (SAF). As for control performed herein, the root directory of a space to which the started print app belongs and a document file, as the format of a file to be acquired, are specified on the folder selection screen, and a folder selection screen 1010 illustrated in FIG. 10B is displayed on the display section 207. That is, the CPU 201 performs control such that the folder selection screen 1010 for selecting a document file (content) that is saved in the electronic device 180 is displayed on the display section 207. The folder selection screen 1010 is an example of a screen for selecting content and is a screen for selecting a folder in which a document file such as a PDF file or a Word file to be printed is stored by a user operation on the touch panel 210. The folder selection screen 1010 is a screen on which a list of all folders in and below the root directory of the space to which the started print app belongs in the electronic device 180 is displayed in a selectable manner. A switching item 1011 that receives an instruction to switch between the personal space 320 and the private space 330 is displayed on the folder selection screen 1010. A touch operation on the switching item 1011 enables the space to which the folders that are displayed on the folder selection screen 1010 belong to be switched. For example, if the private space 330 is switched to the personal space 320, the display of a list of folders in the private space 330 is switched to the display of a list of folders in the personal space 320. That is, the folder selection screen 1010 is a screen on which all folders in and below the root directory of a space that is selected by the switching item 1011 in the electronic device 180 are selectable.

In the case of S508, the print app is started in the private space 330, and accordingly, a screen on which the switching item 1011 is displayed is displayed. This enables a possibility that a file that the user searches for is in the personal space 320 to be suggested and enables the user to easily search for the desired file. Since the print app is started in the private space 330, the second lock is unlocked, and accordingly, it is less of a priority to consider the concealability of the private space 330. The personal space 320 can be fundamentally viewed without unlocking the second lock. Accordingly, in the case of S508, ease of search for the file desired by the user is prioritized over the concealability, and the screen on which the switching item 1011 is displayed is displayed.

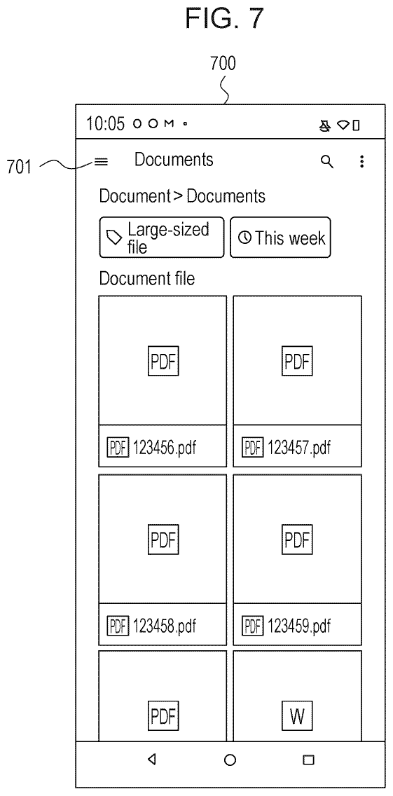

In S509, the CPU 201 displays a file selection screen (a file list screen) by using the OS standard file selection function (that is, the SAF) that is included in the OS standard function 310. As for control performed herein, a hierarchical level below the root directory of the space to which the started print app belongs and the format of a file to be acquired are specified, and the file selection screen 700 illustrated in FIG. 7 is displayed on the display section 207. That is, the CPU 201 performs control such that the file selection screen 700 on which a document file (content) that is saved in the electronic device 180 is selected is displayed on the display section 207. The file selection screen 700 is an example of a content selection screen and a screen for selecting a document file such as a PDF file or a Word file to be printed by a user operation on the touch panel 210. In S509, the file selection screen on which a list of document files is displayed is displayed instead of a folder selection screen on which a list of folders in the space to which the started print app belongs is displayed unlike S508 as described above. The switching item 1011 that receives an instruction to switch between the personal space 320 and the private space 330 is not displayed on the file selection screen. In the case of S509, the print app is started in the personal space 320, and accordingly, the presence of the private space 330 is not recognized by the user of the personal space 320 because the screen on which the switching item 1011 is not displayed is displayed. The concealability of the private space is maintained accordingly. Under the policy in which ease of search for the file desired by the user is prioritized over the concealability of the private space 330, the folder selection screen on which the switching item 1011 is displayed may be displayed in S509 as in S508.

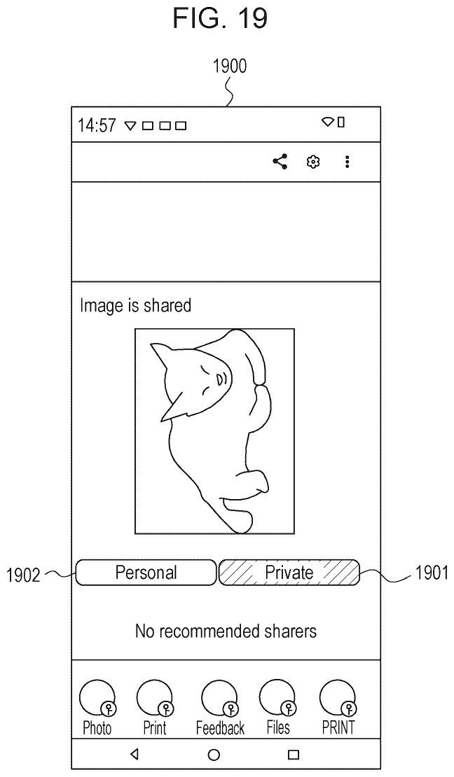

In S510, the CPU 201 performs a file selection process and receives (acquires) file identifying information. The file selection process will be described later with reference to FIG. 19.

In S511, the CPU 201 receives a print setting operation for the selected file from the user, based on the file identifying information that is acquired by the process in S510 and transmits a print job for the selected file to the image forming apparatus 170. Then, the processing returns to S501.

In S512, the CPU 201 determines whether the print app is started in the private space (PrS) 330. A determination method in S512 is the same as the determination method in S507. If the print app is started in the private space 330, the processing proceeds to S513. If not, that is, if the print app is started in the personal space 320, the processing proceeds to S516.

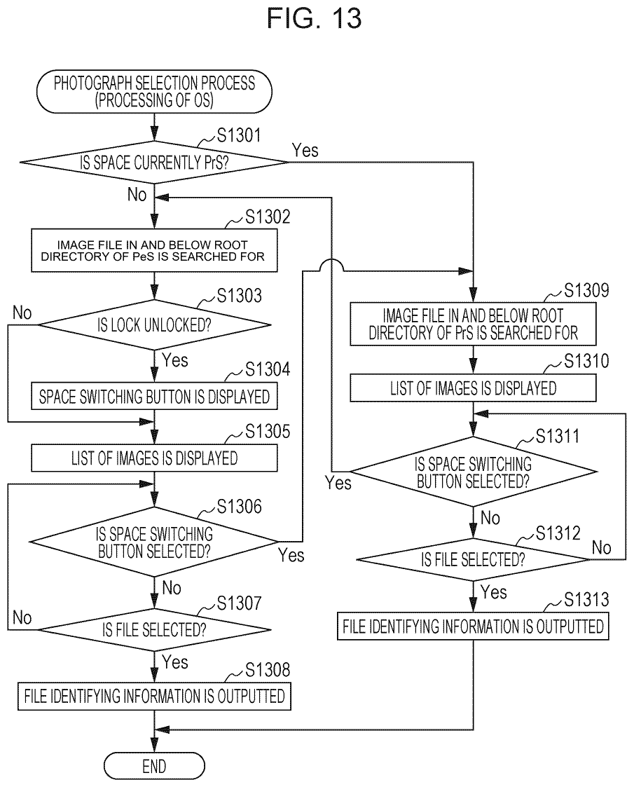

In S513, the CPU 201 performs control such that a photograph selection process is performed by the photo picker 311 of the OS standard function 310 and receives the file identifying information. As for display in the photograph selection process performed by the photo picker 311, a space switching button 1401 or 1601 for switching between the private space 330 and the personal space 320 is displayed when the second lock is unlocked. The details of the photograph selection process in S513 will be described later with reference to FIG. 13.

In S514, the CPU 201 receives a print setting operation for a selected photograph file (an image file) from the user, based on the file identifying information that is acquired by the process in S513, and transmits a print job for the selected photograph file to the image forming apparatus 170. Then, the processing returns to S501.

In S516, the CPU 201 displays a file selection screen by using the OS standard file selection function (that is, the SAF) that is included in the OS standard function 310. As for control performed herein, a hierarchical level below the root directory of the space to which the started print app belongs and an image file, as the format of a file to be acquired, are specified, and the file selection screen for the image file is displayed on the display section 207. The file selection screen that is displayed in S516 has the same screen configuration as a file selection screen displayed in S509. In S509, a document file is displayed as an option, but in S516, an image file is displayed as an option.

In S516, the file selection screen using the SAF is thus displayed instead of the photo picker unlike S513, and the switching item that receives an instruction to switch between the personal space and the private space is not displayed. In the case of S516, the print app is started in the personal space 320, and accordingly, a screen on which the switching item is not displayed is displayed, and consequently, the presence of the private space 330 is not recognized by the user of the personal space 320. The concealability of the private space 330 is maintained accordingly. Under the policy in which ease of search for the file desired by the user is prioritized over the concealability, the file selection screen using the photo picker on which the space switching button 1401 is displayed may be displayed in S516 as in S513.

In S517, the CPU 201 determines whether the photograph printing 602 on the home screen 600 in FIG. 6 is subjected to a touch operation and thereby selected by a user operation on the touch panel 210. If the photograph printing 602 is subjected to a touch operation, the processing proceeds to S513. If the photograph printing 602 is not subjected to a touch operation, the processing proceeds to S518. If the photograph printing 602 is subjected to a touch operation, content to be processed by the photograph printing is selected and printed. That is, a touch to the photograph printing 602 is an operation for selecting the content to be processed (an operation that needs to select the content to be processed). In a case where the photograph printing 602 is touched, and Yes is determined in S517, the processing may proceed to S512 instead of S513.

In S508 and S509, the folder and file selection screens (the SAF), respectively, are used to select a document file. In S513, however, the photo picker 311 is used to select a photograph file.

The reason for using the photo picker 311 to select the photograph file will now be described. The reason is that there are only a few cases where the photo picker 311 acquires permission in advance from the user. In a case where the print app displays a screen for selecting an image file without using the photo picker 311, the selection screen needs to receive an operation of permitting display of each image file one by one from the user. For this reason, an image file of a newly captured photograph is not displayed on the selection screen. The SAF does not need to acquire permission in advance, but enables an image file to be checked only in each folder and has inferior list view overview. Using the photo picker 311, multiple images stored in different folders can be displayed on the same screen. Thus, the SAF has trouble with the operability of image selection. In contrast, the photo picker 311 displays a list of photographs (image files) as selection candidates without acquiring permission in advance from the user and therefore facilitates the selection of an intended photograph.

The reason for using the file/folder selection screens (the SAF) in the case of a document file will now be described.

The reason is that only image files are selection targets for the photo picker 311, and the photo picker 311 cannot display document files as options.

The reason why a method of selection from photographs is provided in the case of document printing will be described. The reason is that in the case of a photograph file (an image file), if the content of the photograph thereof is a photograph of a document, the case is treated as document printing, or the user recognizes it as a document. Specifically, when it is determined in S502 that the document printing 601 is selected and that the content of an image file is a document, print setting initial values such as a sheet size and a sheet type for the document can be used in file print settings in S511 and S514. In a case where a photograph is selected for document printing, the use of the SAF in S516 makes it easier to check a folder than the use of the photo picker 311 with photograph data in corresponding folders. In the display example shown in FIG. 7, an operation on a menu 701 enables a folder to be changed, and display representing a hierarchical level of “Document>Documents” displayed below the menu 701 makes it easy to check the folder. Another folder can be selectable when the display of “Document>Documents” is touched, and the hierarchical level is changed.

The reason why the photo picker 311 is used in S513 for the private space 330, and the file selection screen 700 is displayed by the SAF in S516 for a space other than the private space 330, as in the case of selecting photographs for document printing, will be described. The reason is that the file selection screen 700 (the SAF) is a screen on which a photograph file can be displayed.

In S518, the CPU 201 determines whether the scanning 603 on the home screen 600 in FIG. 6 is subjected to a touch operation and thereby selected by a user operation on the touch panel 210. If the scanning 603 is subjected to a touch operation, the processing proceeds to S519. If the scanning 603 is not subjected to a touch operation, the processing proceeds to S524.

In S519, the CPU 201 transmits a scan job to the image forming apparatus 170 that serves as a scanner. The image forming apparatus 170 performs scanning in accordance with the received scan job and transmits an image acquired by the scanning to the electronic device 180. The CPU 201 of the electronic device 180 receives the image (content) scanned by the image forming apparatus 170 from the image forming apparatus 170 and saves the received image in the storage device 204.

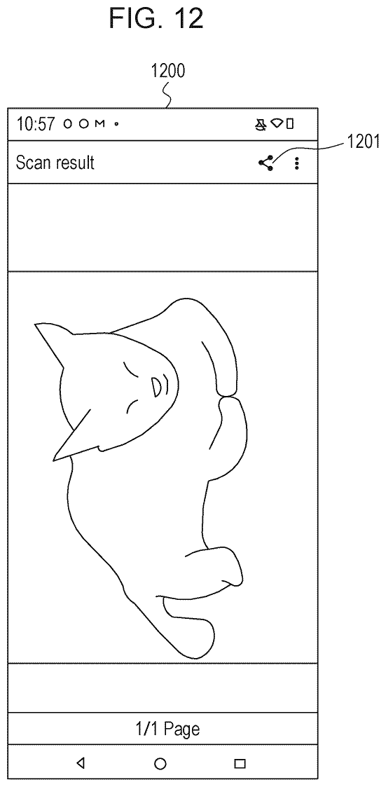

In S520, the CPU 201 performs control such that a processing result screen 1200 for displaying the scanned image is displayed on the display section 207 as illustrated in FIG. 12.

In S521, the CPU 201 determines whether a share button 1201 on the processing result screen 1200 in FIG. 12 is subjected to a touch operation and thereby selected by a user operation on the touch panel 210. If the share button 1201 is subjected to a touch operation, the processing proceeds to S522. If the share button 1201 is not subjected to a touch operation, the processing proceeds to S523.

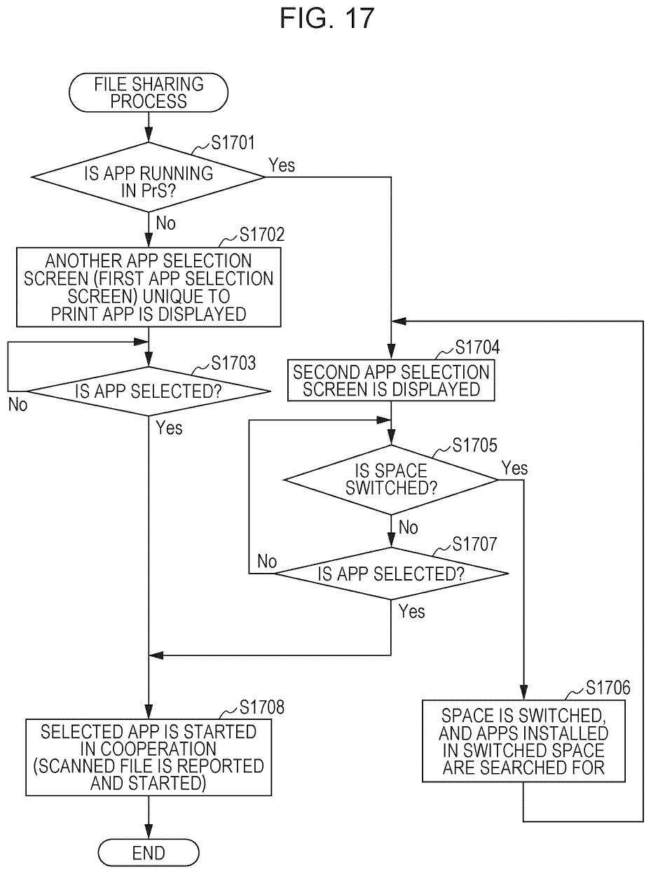

In S522, the CPU 201 performs a file sharing process on the scanned image. The details of the file sharing process in S522 will be described later with reference to FIG. 17.

In S523, the CPU 201 determines whether a “return button” on the processing result screen 1200 in FIG. 12 is subjected to a touch operation by a user operation on the touch panel 210. If the “return button” is not subjected to a touch operation, the processing returns to S521. If the “return button” is subjected to a touch operation, the processing returns to S501.

In S524, the CPU 201 determines whether another button on the home screen 600 in FIG. 6 is subjected to a touch operation by a user operation on the touch panel 210. If another button is subjected to a touch operation, the processing proceeds to S525. If another button is not subjected to a touch operation, the processing proceeds to S526.

In S525, the CPU 201 performs a process based on the other button subjected to the touch operation. Then, the processing proceeds to S526.

In S526, the CPU 201 determines whether an operation of ending the print app is performed by a user operation on the touch panel 210. If the operation of ending the print app is not performed, the processing returns to S501. If the operation of ending the print app is performed, the CPU 201 closes the print app, and the processing of the flowchart in FIG. 5A and FIG. 5B ends.

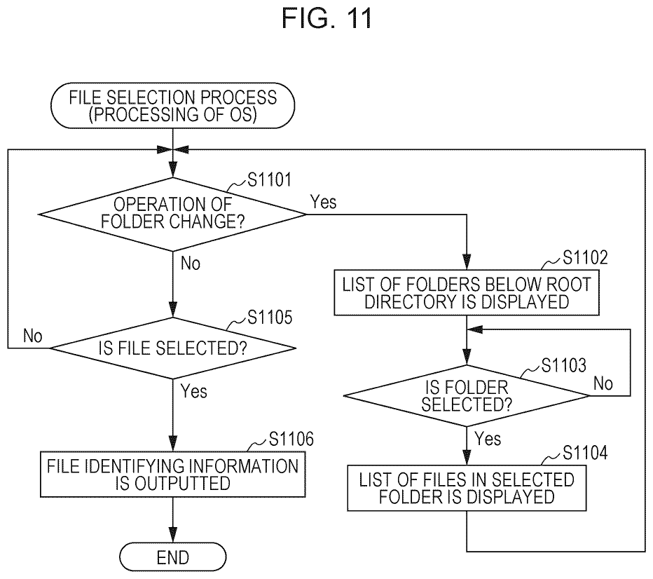

FIG. 11 is a flowchart illustrating the details of the file selection process of S510 in FIG. 5A. The processing of the flowchart in FIG. 11 is processing performed by the file selection function (the SAF) of the OS standard function 310.

In S1101, the CPU 201 determines whether a user operation of folder change is performed by the user performing a touch operation on the menu 701 on the file selection screen 700 or a menu on a folder selection screen 1000 or the folder selection screen 1010 at the same position (the same icon) as the menu 701. If the user operation of folder change is performed, the processing proceeds to S1102. If not, the processing proceeds to S1105.

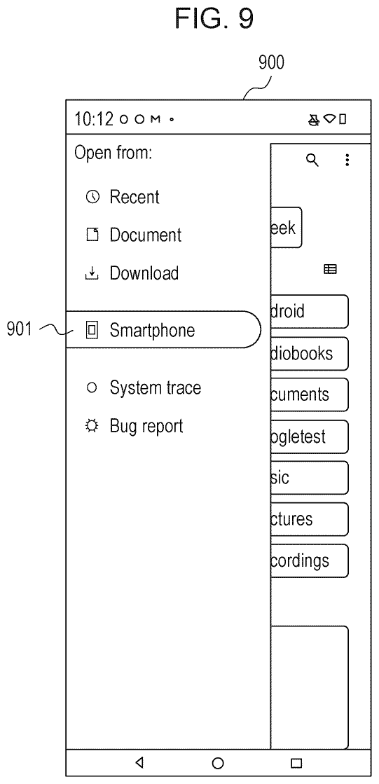

In S1102, the CPU 201 performs control such that a saved area selection screen 900 in FIG. 9 is displayed on the display section 207. If a smartphone 901 is selected on the saved area selection screen 900, the CPU 201 performs control such that the folder selection screen 1000 in FIG. 10A is displayed in a case where the second lock is not unlocked (in a case where the private space is locked). The folder selection screen 1000 is a screen on which all folders in and below the root directory of the space to which the started print app belongs in the electronic device 180 are selectable. In a case where the second lock is unlocked, control is performed such that the folder selection screen 1010 in FIG. 10B is displayed on the display section 207. On the folder selection screen 1010 that is displayed right after the smartphone 901 is operated, all folders in and below the root directory to which the started print app belongs in the electronic device 180 are displayed in a selectable manner. The folder selection screen 1010 also displays the switching item 1011 that receives an instruction to switch between the personal space 320 and the private space 330. By a touch operation on the switching item 1011, it is possible to switch the space to which the folders displayed on the folder selection screen 1010 belong. For example, if the private space 330 is switched to the personal space 320, the display switches from a list of folders in the private space 330 to a list of folders in the personal space 320. That is, the folder selection screen 1010 is a screen that allows the selection of all the folders in and below the root directory of the space selected using the switching item 1011 in the electronic device 180. In a case where an option other than the smartphone 901 is selected in FIG. 9, a folder selection screen corresponding to the selection is displayed. The folder selection screen 1010 is the same as the screen that is displayed in S508 in FIG. 5A. That is, in a case where the second lock is unlocked, including a case where the print app is started in the private space (PrS) 330, the switching item 1011 that receives an instruction to switch between the personal space 320 and the private space 330 is displayed by the process in S1102.

In S1103, the CPU 201 determines whether a folder is selected on the folder selection screen 1000 or 1010. If a folder is selected, the processing proceeds to S1104. If a folder is not selected, the processing returns to S1103.

In S1104, as illustrated in FIG. 7, the CPU 201 performs control such that the file selection screen 700 for selecting a file in the folder that is selected in S1103 is displayed on the display section 207. The switching item that receives an instruction to switch between the personal space 320 and the private space 330 is not displayed on the file selection screen 700. Then, the processing returns to S1101.

In S1105, the CPU 201 determines whether a file is selected on the file selection screen 700. If a file is selected, the processing proceeds to S1106. If a file is not selected, the processing returns to S1101.

In S1106, the CPU 201 outputs the save location of the selected file as file identifying information that is information identifying the selected file. Then, the processing of the flowchart in FIG. 11 ends.

FIG. 13 is a flowchart illustrating the details of the photograph selection process of S513 in FIG. 5B. The processing of the flowchart in FIG. 13 is processing performed by the photo picker 311.

In S1301, the CPU 201 determines whether the print app is currently started in the private space 330. If the print app is started in the private space 330, the processing proceeds to S1309. If not, that is, if the print app is started in the personal space 320, the processing proceeds to S1302.

In S1302, the CPU 201 searches for an image file in and below the root directory of the personal space (PeS) 320. The root directory of the personal space (PeS) 320 is “storage/emulated/0,” for example.

In S1303, the CPU 201 determines whether the second lock is unlocked.

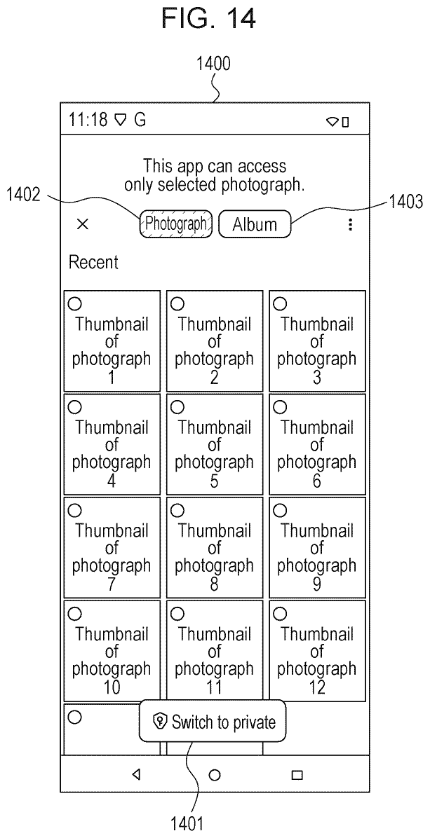

If the second lock is unlocked in S1303, the processing proceeds to S1305 via S1304. In S1305 via S1304, as illustrated in FIG. 14, the CPU 201 performs control such that an image list screen 1400 including the space switching button 1401 is displayed on the display section 207. FIG. 14 illustrates an example of the image list screen that is displayed by the photo picker 311. The space switching button 1401 is a button for switching from an image list screen for the personal space 320 to an image list screen for the private space 330. Then, the processing proceeds to S1306.

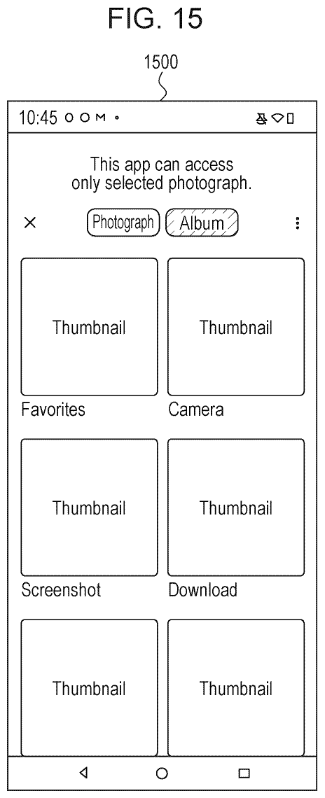

The image list screen 1400 in FIG. 14 illustrates an example of an image list screen in the state where a “photograph” button 1402 is selected. If an “album” button 1403 is selected on the image list screen 1400, the CPU 201 performs control to display an album selection screen 1500 as shown in FIG. 15 on the display section 207. FIG. 15 illustrates an example of the album selection screen that is displayed by the photo picker 311. If a desired album is selected on the album selection screen 1500, the CPU 201 displays an image selection screen for selecting an image belonging to the selected album.

If the lock is not unlocked in S1303, the processing proceeds to S1305 not via S1304. In S1305, the CPU 201 performs control to display on the display section 207 the image list screen 1400 that does not include the space switching button 1401. If the lock is not unlocked, because it is not possible to switch from the personal space 320 to the private space 330, the CPU 201 performs control not to display the space switching button 1401. Then, the processing proceeds to S1306.

In S1306, the CPU 201 determines whether the space switching button 1401 in FIG. 14 is subjected to a touch operation by a user operation on the touch panel 210. If the space switching button 1401 is subjected to a touch operation, the processing proceeds to S1309. If the space switching button 1401 is not subjected to a touch operation, the processing proceeds to S1307. If the second lock is not unlocked, the determination in S1306 is No.

In S1307, the CPU 201 determines whether an image file is selected on the image list screen 1400 in FIG. 14. If an image file is not selected, the processing returns to S1306. If an image file is selected, the processing proceeds to S1308.

In S1308, the CPU 201 outputs the save location of the selected image file as file identifying information that is information identifying the selected image. Then, the processing of the flowchart in FIG. 13 ends.

In S1309, the CPU 201 searches for an image file in and below the root directory of the private space (PrS) 330. The root directory of the private space (PrS) 330 is “storage/emulated/10,” for example.

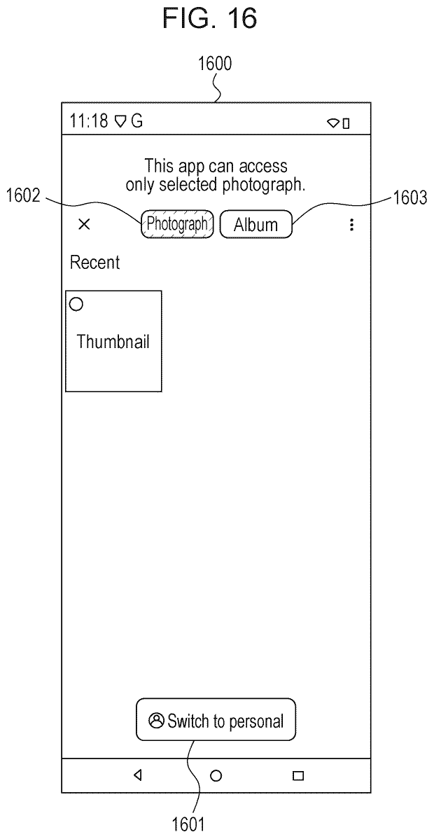

In S1310, the CPU 201 performs control to display an image list screen 1600 including the space switching button 1601 on the display section 207 as illustrated in FIG. 16. FIG. 16 illustrates an example of the image list screen that is displayed by the photo picker 311. The space switching button 1601 is a button for switching from an image list screen for the private space 330 to an image list screen for the personal space 320. Then, the processing proceeds to S1311.

The image list screen 1600 in FIG. 16 illustrates an example of an image list screen in the state where a “photograph” button 1602 is selected. If an “album” button 1603 is selected on the image list screen 1600, the CPU 201 performs control to display an album selection screen similar to the album selection screen 1500 in FIG. 15 on the display section 207. If a desired album is selected on the album selection screen, the CPU 201 displays an image selection screen for selecting an image belonging to the selected album.

In S1311, the CPU 201 determines whether the space switching button 1601 in FIG. 16 is subjected to a touch operation by a user operation on the touch panel 210. If the space switching button 1601 is subjected to a touch operation, the processing proceeds to S1302. In S1302, the CPU 201 performs the above process. If the space switching button 1601 is not subjected to a touch operation, the processing proceeds to S1312.

In S1312, the CPU 201 determines whether an image file is selected on the image list screen 1600 in FIG. 16. If an image file is not selected, the processing returns to S1311. If an image file is selected, the processing proceeds to S1313.

In S1313, the CPU 201 outputs the save location of the selected image file as file identifying information that is information identifying the selected image. Then, the processing of the flowchart in FIG. 13 ends.

FIG. 17 is a flowchart illustrating the details of the file sharing process of S522 in FIG. 5B. FIG. 17 illustrates a flowchart that is performed by the print app.

In S1701, the CPU 201 determines whether the print app is currently started in the private space 330 as in the determination in S507. If the print app is started in the private space 330, the processing proceeds to S1704. If not, that is, if the print app is started in the personal space 320, the processing proceeds to S1702.

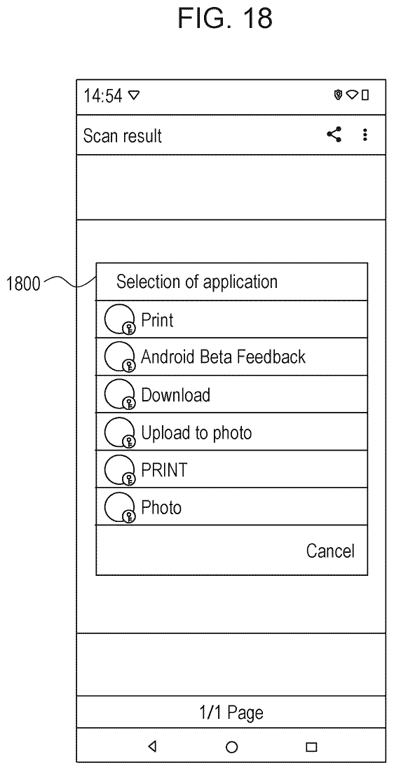

In S1702, the CPU 201 performs control such that an app selection screen 1800 as shown in FIG. 18 is displayed on the display section 207. The app selection screen 1800 (a first app selection screen) is unique to the print app. That is, the app selection screen 1800 is a selection screen for selecting another app (an app other than the print app). The print app has a function that displays the app selection screen 1800. The OS does not have the function to display the app selection screen 1800. In other words, the function that displays the app selection screen 1800 is a function of the print app, not a function of the OS.

The app selection screen 1800 is a selection screen for selecting an app with which the scanned image (the content) is to be shared. On the app selection screen 1800, apps that are installed in the personal space 320 are displayed as options, but apps that are installed in the private space 330 are not displayed as options. The app selection screen 1800 is a screen on which an operation item (a display item such as a private space button 1901 or a personal space button 1902 described later) that switches from one space to another space is not displayed.

In S1703, the CPU 201 determines whether an app with which the scanned image is to be shared is selected on the app selection screen 1800 in FIG. 18. If an app is not selected, the processing returns to S1703. If an app is selected, the processing proceeds to S1708.

In S1704, the CPU 201 performs control such that an app selection screen 1900 (a second app selection screen) as shown in FIG. 19 is displayed on the display section 207 by using the standard sharing function of the OS. The app selection screen 1900 includes the private space button 1901 and the personal space button 1902.

In a case where the print app is started in the private space 330, the private space button 1901 is in a selected state. With the private space button 1901 selected, the CPU 201 performs control such that the app selection screen 1900 on which apps that are installed in the private space 330 are selectable is displayed on the display section 207.

The app selection screen 1900 in FIG. 19 differs from the app selection screen 1800 in FIG. 18 that is displayed in S1702 in having a different display order of options of apps, different selectable options, or both. In S1702, the app selection screen 1800 (the first app selection screen) is displayed instead of the app selection screen 1900 (the second app selection screen) that is displayed by the sharing function provided by the OS. The reason for this is as follows. As for the second app selection screen, the print app cannot be involved in (determine or regulate) the display order (the arrangement order) of apps that are options and whether apps are displayed as options. That is, in some cases, an app that is presumably not selected as a sharer by the print app is displayed in the second app selection screen earlier in the order, and an app that is frequently selected as a sharer by the print app is displayed in the second app selection screen later in the order. As a result, an operation of selecting an app that is frequently selected by the user becomes cumbersome, which is not user-friendly. As for the first app selection screen, on the other hand, the print app can determine (regulate) the display order (the arrangement order) of apps that are options and whether apps are displayed as options. Thus, it is possible to reflect the intention of the manufacturer of the print app, such as prioritizing apps that are frequently selected by users as sharing destinations, or apps that can provide convenient functions when specified as sharing destinations from a print app. This can improve user-friendliness.

In S1705, the CPU 201 determines whether the private space button 1901 or the personal space button 1902 in FIG. 19 is subjected to a touch operation by a user operation on the touch panel 210. If the private space button 1901 or the personal space button 1902 is subjected to a touch operation, the processing proceeds to S1706. If the private space button 1901 or the personal space button 1902 is not subjected to a touch operation, the processing proceeds to S1707.

In S1706, the CPU 201 searches for apps that are installed in the space (the switched space) corresponding to the private space button 1901 or the personal space button 1902 that is determined as the touched button in S1705. That is, in a case where the private space button 1901 is touched, the CPU 201 searches for apps that are installed in the private space 330. That is, in a case where the personal space button 1902 is touched, the CPU 201 searches for apps that are installed in the personal space 320. Then, the processing proceeds to S1704, and an app selection screen for apps searched in S1706, that is, apps that are installed in the switched space, is displayed. More specifically, in a case where the personal space button 1902 is subjected to a touch operation in S1705, control is performed such that the personal space button 1902 is brought into a selected state, and the app selection screen 1900 is displayed with apps that are installed in the personal space 320 being selectable. In a case where the private space button 1901 is touched in S1705, control is performed such that the private space button 1901 is brought into a selected state, and the app selection screen 1900 is displayed with apps that are installed in the private space 330 being selectable.

As described above, if the sharing function provided by the OS is used, it is possible to display a screen that allows the selection of an app installed in the private space 330 and a screen that allows the selection of an app installed in the personal space 320 by switching the screens. That is, if the sharing function provided by the OS is used, it is possible to select both an app installed in the private space 330 and an app installed in the personal space 320.

In S1707, the CPU 201 determines whether an app is selected as a sharer on the app selection screen 1900. If an app is not selected, the processing returns to S1705. If an app is selected, the processing proceeds to S1708.

In S1708, the CPU 201 notifies the selected app of a scanned image file, starts the selected app as a sharer app in cooperation, and processes the image file using the app (the sharer app). Then, the processing of the flowchart in FIG. 17 ends.

According to the present exemplary embodiment described above, a content selection screen including a switching button for displaying a content in another space can be displayed if an app is started in the private space 330 or the personal space 320 in the cases of the document printing 601 and the photograph printing 602. This facilitates a search for desired content even in a case where the desired content is present in a space that differs from a space in which the app is started.

In an example described above, the photo picker 311 performs the photograph selection process in S513 in FIG. 5A and FIG. 5B. However, this is not a limitation, and the print app may perform the photograph selection process. In a case where the photograph printing is selected in S517, whether the print app is started in the private space 330 may be determined, the print app may perform the photograph selection process in the case of the personal space 320, and the photo picker 311 may be used in the case of the private space 330. This facilitates access to content in the personal space 320 and the private space 330 by using the space switching button in a case where the print app is started in the private space 330.

In the file sharing process in FIG. 17, whether the app selection screen unique to the print app is displayed or whether an OS standard app selection screen is displayed is determined based on whether a running app is in the private space 330. In addition, whether a screen on which an app in another space is selectable is displayed is determined based on whether the running app is in the private space 330. In this way, the sharing process can be more suitably performed depending on the space of the running app.

Although in FIG. 5A and FIG. 5B, a description has been given using the processing of a print app (a printer control app) as an example, the present disclosure is not limited to a print app and is applicable to various apps. For example, embodiments of the present disclosure are applicable to an image viewing app (an album app), an online storage management app, an SNS app, a message app, an email app, a communication app, an image editing app, or an Internet-of-Things (IoT) device management app. The electronic device 180 is not limited to a smartphone, and is applicable to an electronic device such as a tablet, a personal computer, a smartwatch, a game apparatus, a television, a set-top box, or a moving image reproduction apparatus that is capable of operating by installing an app.

The above various types of control performed by the CPU 201 in the description may be performed by a single piece of hardware, or the processing of the above various types of control may be shared by a plurality of pieces of hardware (e.g., a plurality of processors or circuits), thereby controlling the entirety of the apparatus.

The present disclosure is described in detail above based on its suitable exemplary embodiment. However, the present disclosure is not limited to this specific embodiment, and various embodiments are included in the present disclosure without departing from the spirit of the disclosure. The embodiment described above merely corresponds to an embodiment of the present disclosure, and embodiments can be appropriately combined together.

In the above exemplary embodiments, a description has been given using as an example a case where embodiments of the present disclosure are applied to a smartphone. The present disclosure, however, is not limited to this example, and is applicable to any electronic device 180 capable of operating by installing an app. That is, the present disclosure is applicable to a personal computer, a personal digital assistant (PDA), a mobile phone terminal, a mobile image viewer, a music player, a game apparatus, or an electronic book reader.

According to embodiments of the present disclosure, in a mechanism for managing an app and content in association with any of a plurality of spaces, a user is enabled to operate the app and the content more suitably.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-205842, filed Nov. 26, 2024, the entirety of which is incorporated herein by reference.

What is claimed is:

1. A non-transitory computer-readable storage medium storing an application program including instructions, which when executed by one or more processors of an electronic device, in which each of a plurality of applications is managed in association with any of a plurality of spaces including a first space in which a lock does not need to be unlocked to access the first space and a second space in which the lock needs to be unlocked to access the second space, cause the electronic device to:
perform control in response to an operation for selecting content to be processed such that,
in a case where the application program is associated with the first space, a first screen that is used for selecting content saved in association with the first space is displayed, and on the first screen, a first display item enabling selection of content saved in association with the first space or the second space other than a space with which the application program is associated is not displayed, and,
in a case where the application program is associated with the second space, a second screen that is used for selecting content saved in association with the second space is displayed, and on the second screen, the first display item is displayed.

2. The non-transitory computer-readable storage medium according to claim 1,
wherein the first screen is a file list screen on which one or more files are displayed as candidates for content to be selected, and
wherein the second screen is a folder list screen on which one or more candidate folders are displayed for enabling selection of a folder in which content to be selected is stored.

3. The non-transitory computer-readable storage medium according to claim 2,
wherein the first screen and the second screen are displayed by a standard first function of an operating system of the electronic device.

4. The non-transitory computer-readable storage medium according to claim 3,
wherein, in response to the selection of a folder from among the one or more candidate folders displayed on the second screen, the first screen on which one or more files that are stored in the selected folder are displayed as candidates for content to be selected is displayed.

5. The non-transitory computer-readable storage medium according to claim 3,
wherein the operating system is Android, and the standard first function is Storage Access Framework.

6. The non-transitory computer-readable storage medium according to claim 3,
wherein the operating system is Android, the standard first function is Storage Access Framework, and a standard second function is Photo Picker.

7. The non-transitory computer-readable storage medium according to claim 1,
wherein the first screen is displayed by a standard first function of an operating system of the electronic device, and
wherein the second screen is displayed by a standard second function of the operating system of the electronic device.

8. The non-transitory computer-readable storage medium according to claim 1,
wherein the instructions, when executed by the one or more processors, cause the electronic device to transmit a print job for content that is selected based on an operation on the first screen or the second screen.

9. The non-transitory computer-readable storage medium according to claim 1,
wherein the content is a document file or an image file.

10. The non-transitory computer-readable storage medium according to claim 1,
wherein a screen for selecting the content saved in association with the first space is displayed based on an operation on the first display item that is displayed on the second screen.

11. The non-transitory computer-readable storage medium according to claim 1,
wherein the instructions, when executed by the one or more processors, cause the electronic device to perform control in response to an operation for sharing content such that,
in a case where the application program is associated with the first space, a third screen that is used for selecting an application with which the content is to be shared is displayed, and on the third screen, one or more applications associated with the first space are displayed as options for selection and a second display item enabling selection of an application associated with the first space or the second space other than a space with which the application program is associated is not displayed, and,
in a case where the application program is associated with the second space, a fourth screen that is used for selecting an application with which the content is to be shared is displayed, and on the fourth screen, one or more applications associated with the second space are displayed as options for selection and the second display item is displayed.

12. The non-transitory computer-readable storage medium according to claim 1,
wherein the electronic device becomes usable by unlocking a device lock, and
wherein the unlocking of the lock to access the second space differs from the unlocking of the device lock in at least one of a timing or an unlocking key.

13. The non-transitory computer-readable storage medium according to claim 12,
wherein, in a case where the lock preventing access to the second space is not unlocked, an application associated with the second space is hidden in a most recent view, a notification, a setting, or another application.

14. The non-transitory computer-readable storage medium according to claim 1,
wherein the first space and the second space have respective root directories in which content and an application are saved.

15. The non-transitory computer-readable storage medium according to claim 1,
wherein, in a case where the application program is to be used in each of the first space and the second space, the application program is installed in each of the first space and the second space and each installed instance of the application program is the same application program.

16. The non-transitory computer-readable storage medium according to claim 15,
wherein a startup icon of the installed instance of the application program associated with the first space and a startup icon of the installed instance of the application program associated with the second space are displayed in respective display areas of the electronic device.

17. The non-transitory computer-readable storage medium according to claim 1,
wherein an application or content in the first space cannot be moved to the second space by a user operation.

18. A non-transitory computer-readable storage medium storing an application program including instructions, which when executed by one or more processors of an electronic device, in which each of a plurality of applications is managed in association with any of a plurality of spaces including a first space in which a lock does not need to be unlocked to access the first space and a second space in which the lock needs to be unlocked to access the second space, cause the electronic device to:
perform control in response to an operation for sharing content such that,
in a case where the application program is associated with the first space, a first screen that is used for selecting an application with which the content is to be shared is displayed, and on the first screen, one or more applications associated with the first space are displayed as options for selection and a first display item enabling selection of an application associated with the first space or the second space other than a space with which the application program is associated is not displayed, and,
in a case where the application program is associated with the second space, a second screen that is used for selecting an application with which the content is to be shared is displayed, and on the second screen, one or more applications associated with the second space are displayed as options for selection and the first display item is displayed.

19. The non-transitory computer-readable storage medium according to claim 18,
wherein the first screen is displayed by a function of the application program, and
wherein the second screen is displayed by a standard sharing function of an operating system of the electronic device.

20. The non-transitory computer-readable storage medium according to claim 19,
wherein the operating system is Android.

21. The non-transitory computer-readable storage medium according to claim 18,
wherein an arrangement order of a plurality of applications that are displayed on the first screen is defined by the application program, and
wherein an arrangement order of a plurality of applications that are displayed on the second screen is not defined by the application program.

22. The non-transitory computer-readable storage medium according to claim 18,
wherein one or more applications associated with the first space are displayed as options for selection, based on an operation on the first display item that is displayed on the second screen.

23. The non-transitory computer-readable storage medium according to claim 18,
wherein the content is a scanned image.

24. The non-transitory computer-readable storage medium according to claim 23,
wherein the first screen and the second screen are screens for selecting applications with which the scanned image based on a scan job that is transmitted from the electronic device to a scanner is to be shared.

25. An electronic device, in which each of a plurality of applications is managed in association with any of a plurality of spaces including a first space in which a lock does not need to be unlocked to access the first space and a second space in which the lock needs to be unlocked to access the second space, the electronic device comprising:
at least one processor and at least one memory coupled to the at least one processor storing instructions that, when executed by the at least one processor, cause the at least one processor to function as:
a display control unit configured to perform control in response to an operation for selecting content to be processed such that,
in a case where a running application program is associated with the first space, a first screen that is used for selecting content saved in association with the first space is displayed, and on the first screen, a first display item enabling selection of content saved in association with the first space or the second space other than a space with which the application program is associated is not displayed, and,
in a case where the application program is associated with the second space, a second screen that is used for selecting content saved in association with the second space is displayed, and on the second screen, the first display item is displayed.

26. An electronic device, in which each of a plurality of applications is managed in association with any of a plurality of spaces including a first space in which a lock does not need to be unlocked to access the first space and a second space in which the lock needs to be unlocked to access the second space, the electronic device comprising:
at least one processor and at least one memory coupled to the at least one processor storing instructions that, when executed by the at least one processor, cause the at least one processor to function as:
a display control unit configured to perform control in response to an operation for sharing content such that,
in a case where a running application program is associated with the first space, a first screen that is used for selecting an application with which the content is to be shared is displayed, and on the first screen, one or more applications associated with the first space are displayed as options for selection and a first display item enabling selection of an application associated with the first space or the second space other than a space with which the application program is associated is not displayed, and,
in a case where the application program is associated with the second space, a second screen that is used for selecting an application with which the content is to be shared is displayed, and on the second screen, one or more applications associated with the second space are displayed as options for selection and the first display item is displayed.

27. A control method for controlling an electronic device, in which each of a plurality of applications is managed in association with any of a plurality of spaces including a first space in which a lock does not need to be unlocked to access the first space and a second space in which the lock needs to be unlocked to access the second space, the method comprising a display control step of:
performing control in response to an operation for selecting content to be processed such that,
in a case where a running application program is associated with the first space, a first screen that is used for selecting content saved in association with the first space is displayed, and on the first screen, a first display item enabling selection of content saved in association with the first space or the second space other than a space with which the application program is associated is not displayed, and,
in a case where the application program is associated with the second space, a second screen that is used for selecting content saved in association with the second space is displayed, and on the second screen, the first display item is displayed.

28. A control method for controlling an electronic device, in which each of a plurality of applications is managed in association with any of a plurality of spaces including a first space in which a lock does not need to be unlocked to access the first space and a second space in which the lock needs to be unlocked to access the second space, the method comprising a display control step of:
performing control in response an operation for sharing content such that,
in a case where a running application program is associated with the first space, a first screen that is used for selecting an application with which the content is to be shared is displayed, and on the first screen, one or more applications associated with the first space are displayed as options for selection and a first display item enabling selection of an application associated with the first space or the second space other than a space with which the application program is associated is not displayed, and,
in a case where the application program is associated with the second space, a second screen that is used for selecting an application with which the content is to be shared is displayed, and on the second screen, one or more applications associated with the second space are displayed as options for selection and the first display item is displayed.
